(19) United States
(12) Patent Application Publication
(10) Pub. No.: US 2016/0039491 A1
(43) Pub. Date: Feb. 11, 2016

(54) BICYCLE WITH DISC BRAKES REMOVABLE FROM THE RELATIVE WHEEL

(71) Applicant: Angelo MORELLI, Pontenure (PC) (IT)

(72) Inventor: Angelo MORELLI, Pontenure (PC) (IT)

(21) Appl. No.: 14/610,302

(22) Filed: Jan. 30, 2015

(30) Foreign Application Priority Data
Aug. 6, 2014 (IT) MI2014A001452

(51) Int. Cl. B62L 1/00; B62K 25/00

(52) U.S. Cl. CPC B62L 1/00; B62K 25/00

(57) ABSTRACT

Bicycle having disc brakes, transmission device including transmission element rotatably integral with drive wheel and coaxial thereto, frame with front and rear forks; rotatable removable support for front free wheel hub and rear drive wheel hub respectively at two ends of the arms of each fork, the support including a tie-rod in coaxial through-hole in the hub and holes at each fork arm free end, the tie-rod, when tensioned, allowing holding the wheel on the corresponding fork. The brake with disc and caliper on at least one side of at least one wheel. The disc coaxial with the relative wheel, the caliper with pads fixed to the corresponding arm. The discs supported rotatably, by the same arms. Elements for establishing a positive-locking fit allowing rotatably connecting the relative disc with the relative wheel hub when the tie-rod is tensioned and nullifying the positive-locking fit when the tie-rod is released.

This invention relates to bicycles equipped with disc brakes and with a transmission device comprising a transmission element rotatably integral with the drive wheel and coaxial therewith.

Note that the term bicycle is intended here to indicate also a so-called bicycle with pedal assistance, that is, a bicycle in which a motor (in particular an electric motor) can assist the cyclist in pedalling or replace him in operating the drive wheel.

As is well known, in bicycles the transmission of the movement to the rear drive wheel occurs using a chain-transmission device, comprising, as its last element, a rotating transmission element, coaxial with the drive wheel and firmly fixed to the hub thereof. This transmission element is normally equipped with a so-called “freewheel”.

In its simplest form, the above-mentioned transmission element comprises a chain sprocket, fixed coaxially with the drive wheel and which engages with the transmission chain with which is engaged also a second chain sprocket, supported rotatably by the frame of the bicycle and which is operated by the pedals and/or by a motor in the case of bicycles with pedal assistance.

It is also well known that the above-mentioned transmission element, in the case of geared bicycles, comprises several chain sprockets (the so-called sprocket unit), of different diameters, arranged in a graduated manner and coaxially with the rear drive wheel of the bicycle and connected together and to said wheel. As is known, gear units can be found on the market for bicycles that use transmission elements having even more than ten sprockets. By operating the gear control it is possible to engage, as chosen by the cyclist, the chain with one of the sprockets of the above-mentioned transmission element.

The fact that the above-mentioned transmission element is coaxially fixed to the rear drive wheel of the bicycle means that the rear wheel is however different from the front one, which is free.

Bicycles already exist (namely mountain bikes) that are equipped with disc brakes. Although road competition bikes with disc brakes have also been produced, in practice, these cannot be used, however, in competitions for reasons that will be explained later.

Furthermore, the various manufacturers produce disc brakes with discs of very different diameters and thicknesses and also of different materials. In particular, the disc is fixed coaxially to the wheel hub and has on each of its two faces a so-called circular-crown-shaped braking track. The brake disc also comprises a so-called calliper that allows so-called pads to be pressed against relative braking tracks. The calliper is fixed to the bicycle frame and in particular to the relative fork.

It is perfectly obvious that the presence on the wheels of a bicycle, and even more so of a road competition bicycle, of the above-mentioned disc enormously complicates the work of whoever must change the wheels, considering the variety of spares that must be kept available. Indeed, apart from bearing in mind that the front wheel is free and therefore differs from the rear wheel, which is a drive wheel, and therefore in each case for any one bicycle two types of wheel must be kept available, the fact that the diameter of the disc, its thickness and also the material of which it is made (materials with a different thermal capacity have a different degree of heat dissipation and give rise to a different type of braking) can be different, results in a considerable increase in the number of spare wheels to be kept available.

This constitutes a particularly acute problem not only for road competition bicycles, but also for other types of bicycles.

Remember also that between the braking track of the disc and relative pad there must necessarily be a very small space (on average 0.5 mm either side), which prevents, particularly in the case of road competition bicycles (in which the travel of the brake control must be as short as possible), even in the presence of discs of an identical diameter, thickness and material, the possibility of restoring the degree of reliability, efficiency and safety of braking that existed prior to replacing the wheel, other than by taking time that is incompatible with any type of competition and in any event extremely long, since in any case workshop tools must be used.

Furthermore, since the disc is fixed coaxially to the wheel hub, it may arise—especially in the case of competition bicycles (particularly on a bend or when the cyclist rises in the saddle to start off), the wheels being thin and light—that the wheels (especially the rear one) undergo elastic deformation that can cause the disc to interfere with the pads of the relative calliper, resulting in an undesired braking action.

One aim of the present invention therefore consists in producing a bicycle equipped with disc brakes, that overcomes these drawbacks and in particular in producing a road competition bicycle, equipped with disc brakes, whose wheels can easily and quickly be changed by the wheel-changing technicians or by the team members and even exchanged between the riders themselves, without jeopardising braking efficiency, reliability and safety, and also without undesirable braking actions due to the deformation of the wheels, and also significantly reduces the number of spare wheels to be kept available.

Returning to the drawbacks that exist chiefly on road competition bicycles equipped with disc brakes, in the presence of intense braking the discs (normally 120-160 mm in diameter), as a result of the friction due to the pads pressing hard against the braking tracks, are subject to extremely rapid overheating. This occurs for example downhill, because the brakes are applied frequently and intensely, or also on the flat, when travelling in a group at high speed and bends, roundabouts or humps must be negotiated, which require rapid deceleration in order to avoid collisions or falls, or at least to mitigate their consequences.

The discs dissipate heat efficiently when the wheel is moving, much less so when the wheel is stationary, thus with an overheated disc and stationary wheel, the overheating persists for a considerable time and can sometimes cause serious burns for the riders, particularly in the event of group falls.

Furthermore, an overheated disc makes it more difficult, and with the added risk of burns, to intervene on a bicycle in order to carry out any assistance operations that may be necessary, for example, interventions by the wheel-changing technicians to replace a damaged wheel and placing the replaced wheel inside the service vehicle. For these technicians, the possibility of using protective gloves is ruled out since they prevent them from acting with the required speed (the intervention must last only a few seconds) and precision.

Remember also that the above-mentioned discs are sharp, so added to the danger of burning oneself is that of cutting oneself.

The fact is that the present state of the art makes it absolutely impossible for a cyclist taking part in a race on a road competition bicycle, equipped with disc brakes, to re-join the race in a few moments (opponents won't wait!) with a new wheel and the relative disc braking system in perfect working order, even if the operation is performed by highly qualified personnel and discs of identical diameter, thickness and material are used, because the adjustments that must be performed in order to achieve perfect efficiency of the disc brake (which in particular requires the pads to be at the correct distance from the relative braking tracks) are too many and too sophisticated. The conclusion is that at present disc brakes cannot in practice be used for road competition bicycles. This is confirmed by the fact that disc brakes are not permitted on bicycles used in competitions under the aegis of the International Cycling Union (UCI).

Note that, as regards mountain bikes, the problem is less acute because mountain bike competitions are not on the road but on dirt tracks, the speed is much slower, no wheel-changing service is provided because it is unnecessary and less precision is required between the disc and relative pads.

Furthermore, road competition bicycles, equipped with disc brakes, may have the serious drawback that the front wheel of a rider's bicycle becomes wedged in the space between the disc and spokes of the rear wheel of the bicycle of the rider in front or, in some cases, between the spokes and sprocket unit. The above-mentioned space in fact constitutes a real “trap” for the thin front wheel of a competition bicycle, a trap that is not easy to avoid, particularly in the case of sudden slowing down, unless the riders are “wheel-to-wheel” with the utmost care and concentration.

Another aim of the present invention therefore consists in producing a bicycle with disc brakes that does not have the above-described drawbacks and in particular does not present the above-mentioned “trap”.

The inventor of the present invention has also realised that it would be of considerable advantage to have a bicycle with disc brakes on which both wheels are identical, which is currently not the case because the above-mentioned transmission element is connected to the hub of the rear drive wheel.

It is also well known that in the case of cycling races and competitions, the teams have personnel dedicated to changing wheels. Furthermore, the regulations state that the race organiser must provide its own personnel to assist the racers if a wheel requires replacement, a replacement that must obviously occur as quickly as possible. In any case, all other conditions being equal, two types of spare wheel must be made available, namely front wheels and rear wheels, which differ due to the presence on the rear wheel hub of the above-mentioned transmission element.

Remember also that cyclists who take part in a race do not usually use identical bicycles (various manufacturers are involved, each with similar but never identical products). In particular, the bicycles of racers in the various teams may have the above-mentioned transmission element composed of a different number of sprockets (i.e. have different sprocket units). Furthermore, these sprockets, even if of the same number, may be of different thickness and the distances between these sprockets may be different. All this gives an idea of how the number of spare wheels that must be kept available increases enormously.

Another aim of the present invention therefore consists in producing in general a bicycle with disc brakes that do not have the above-described drawbacks and in particular have two identical wheels.

Yet another aim consists in producing a bicycle with disc brakes for which changing the wheels is achieved easily and quickly.

The above-mentioned aims are achieved and the relative technical problems resolved thanks to a bicycle that has disc brakes in which the drive wheel is operated by a transmission device comprising a transmission element rotatably integral with the drive wheel and that has the features described in the accompanying claims.

A better understanding of the invention will emerge from the following description of two of its embodiments, given purely by way of example. This description will refer to the accompanying drawings, in which:

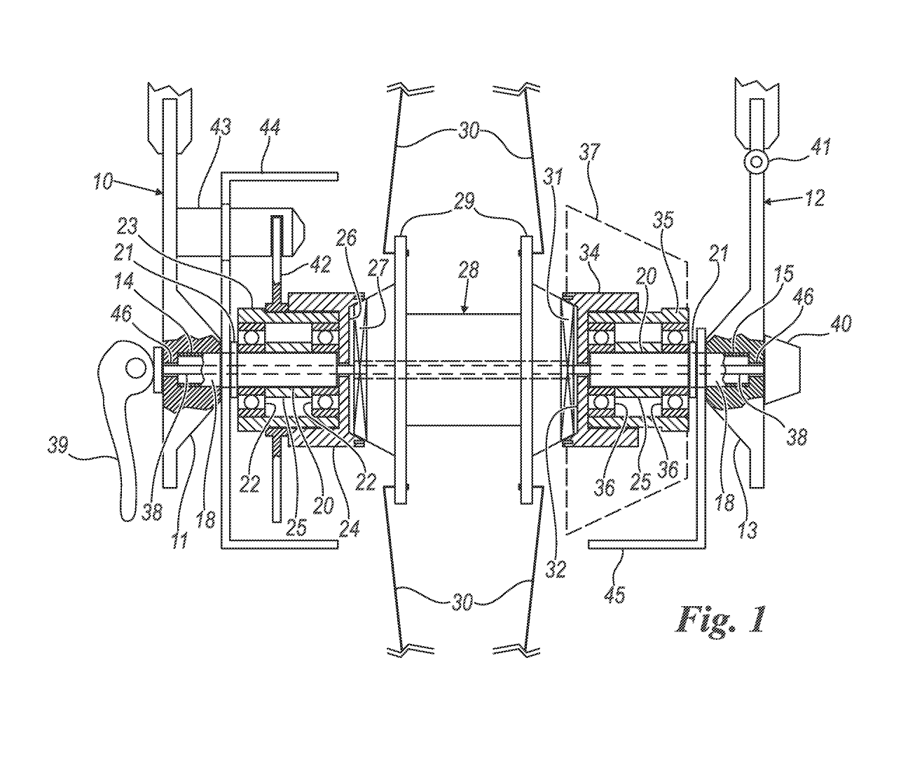

FIG. 1 is a schematic top view, with cutaway sections, of a portion of a first embodiment of a bicycle according to the present invention, in particular with disc brakes, this portion concerning the bottom part of the rear fork, the hub of the relative wheel and the mechanisms that enable the fork to support the hub;

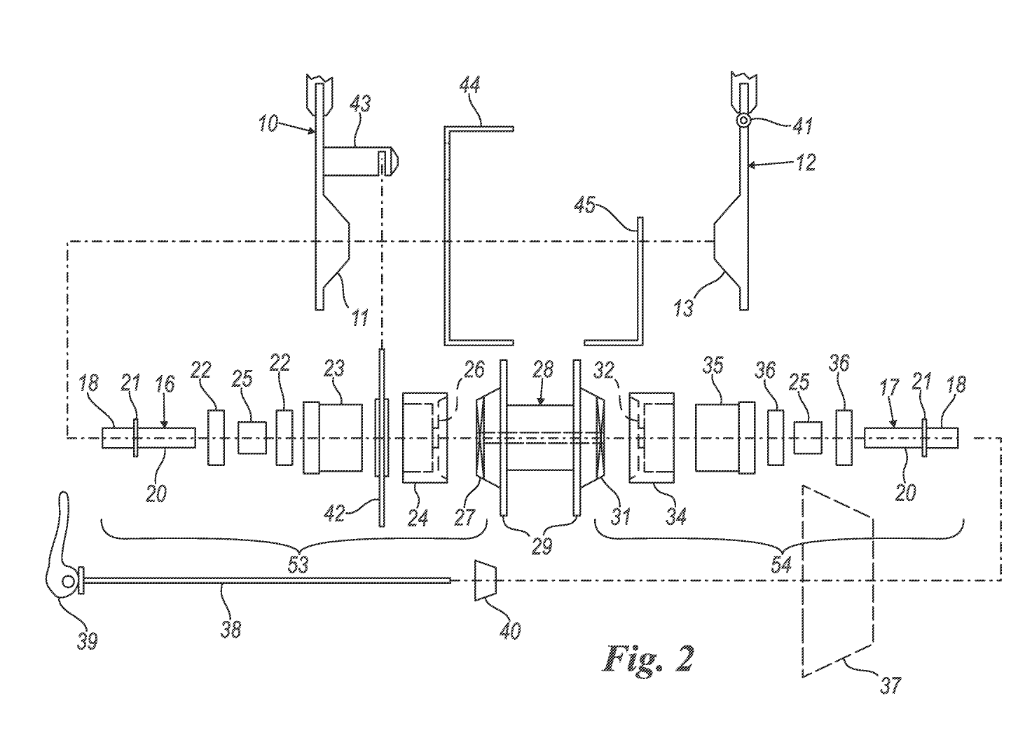

FIG. 2 is an exploded view of the parts in FIG. 1, the parts being shown slightly smaller;

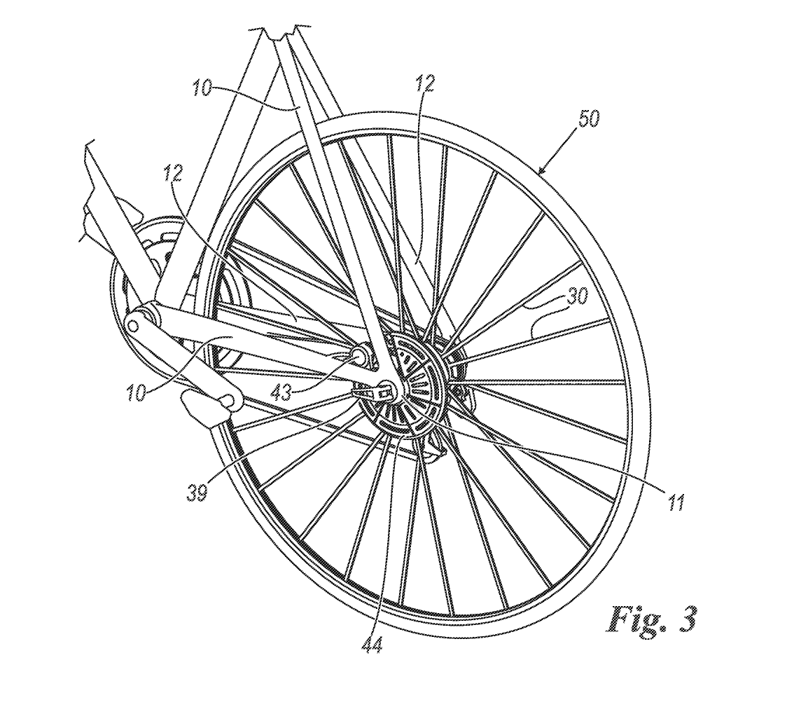

FIG. 3 is a schematic perspective view of the rear part of a second embodiment of a bicycle according to the invention;

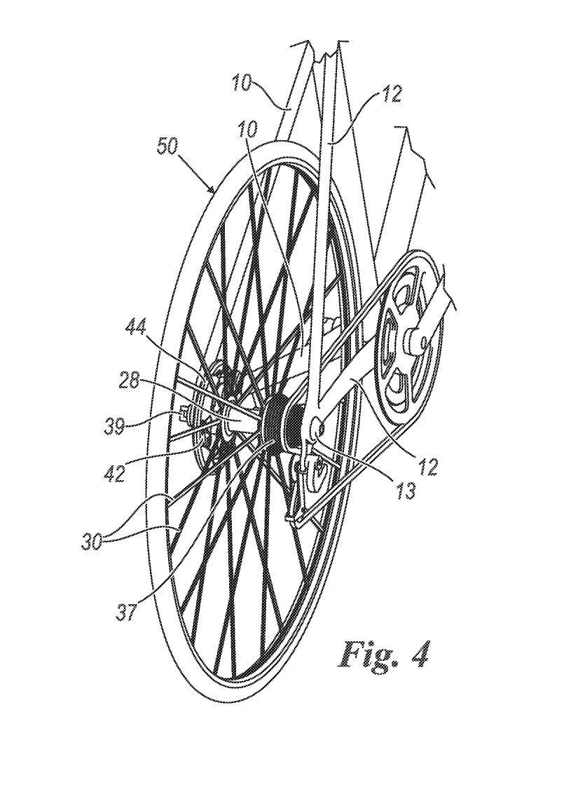

FIG. 4 is a perspective view of the same rear part shown in FIG. 3, but from a different viewpoint;

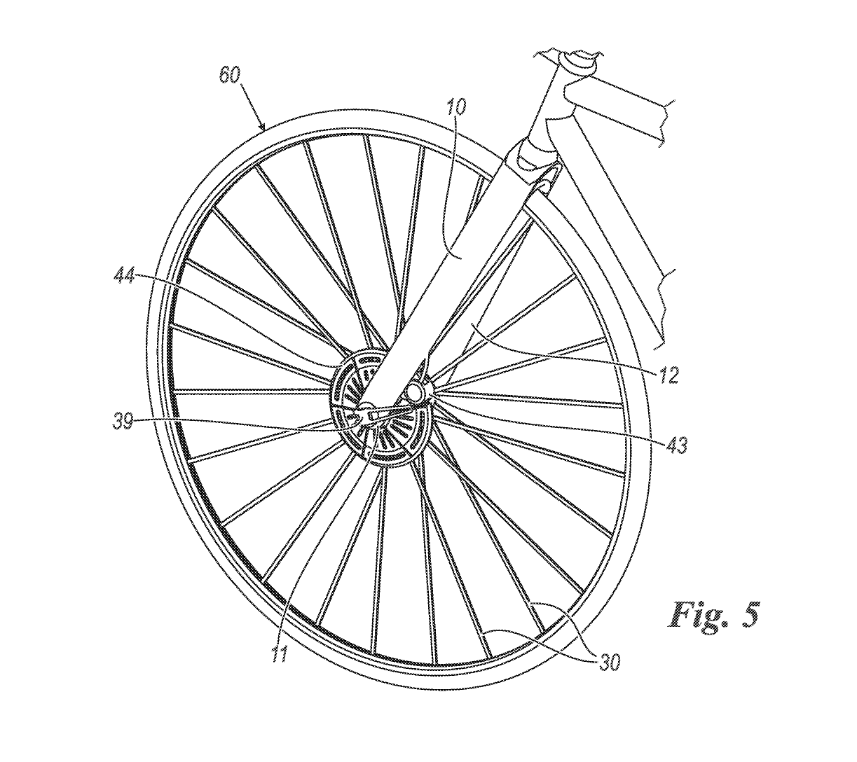

FIG. 5 is a schematic perspective view of the front part of the above-mentioned second embodiment of the invention;

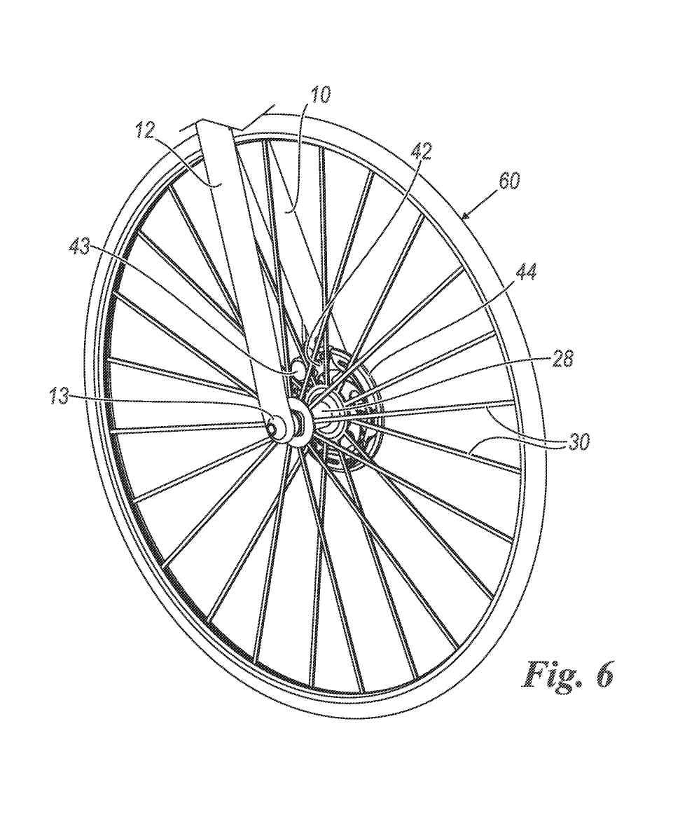

FIG. 6 is a perspective view of the same front part shown in FIG. 5, but from a different viewpoint;

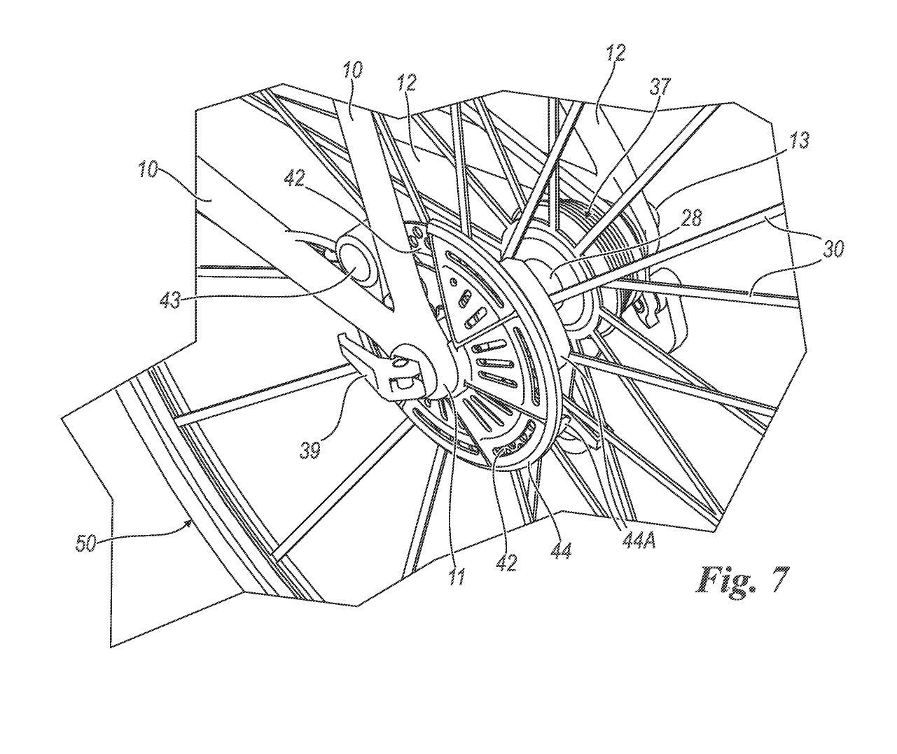

FIG. 7 is an enlarged perspective view of a portion of the rear part shown in FIG. 3;

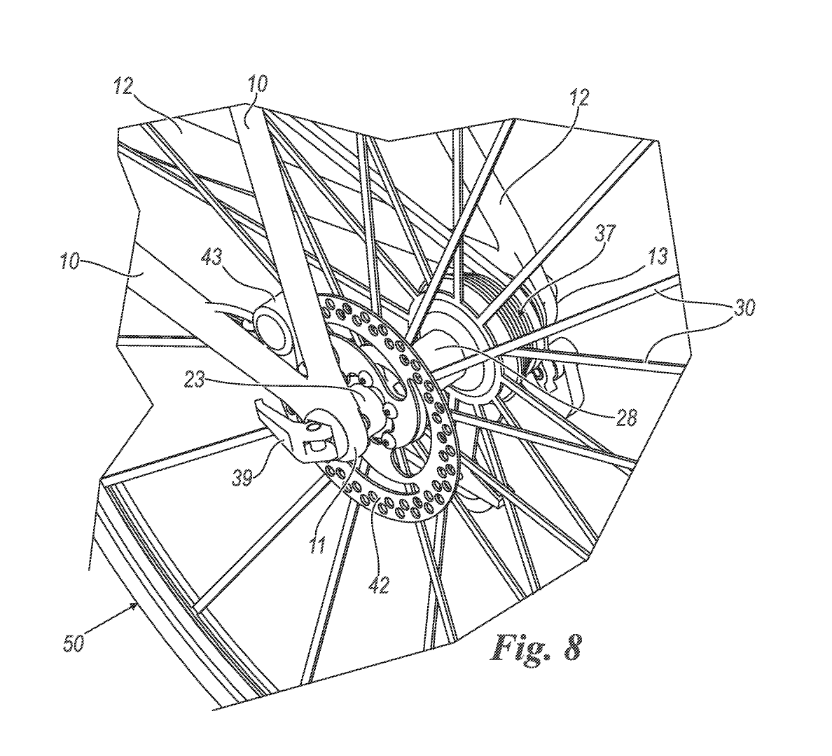

FIG. 8 is similar to FIG. 7, with the difference that the guard that protects the brake disc has been removed;

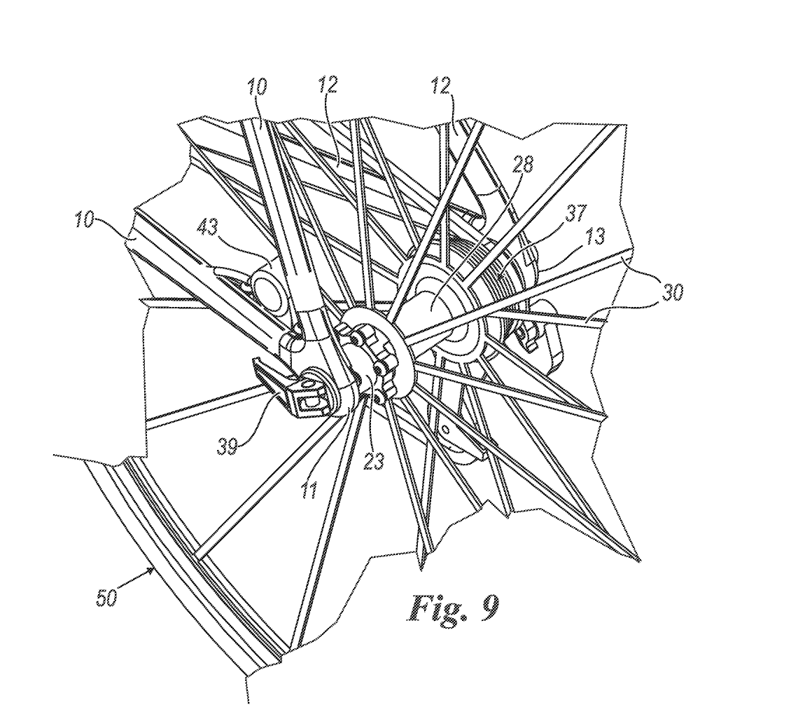

FIG. 9 is similar to FIG. 8, with the difference that the brake disc has also been removed;

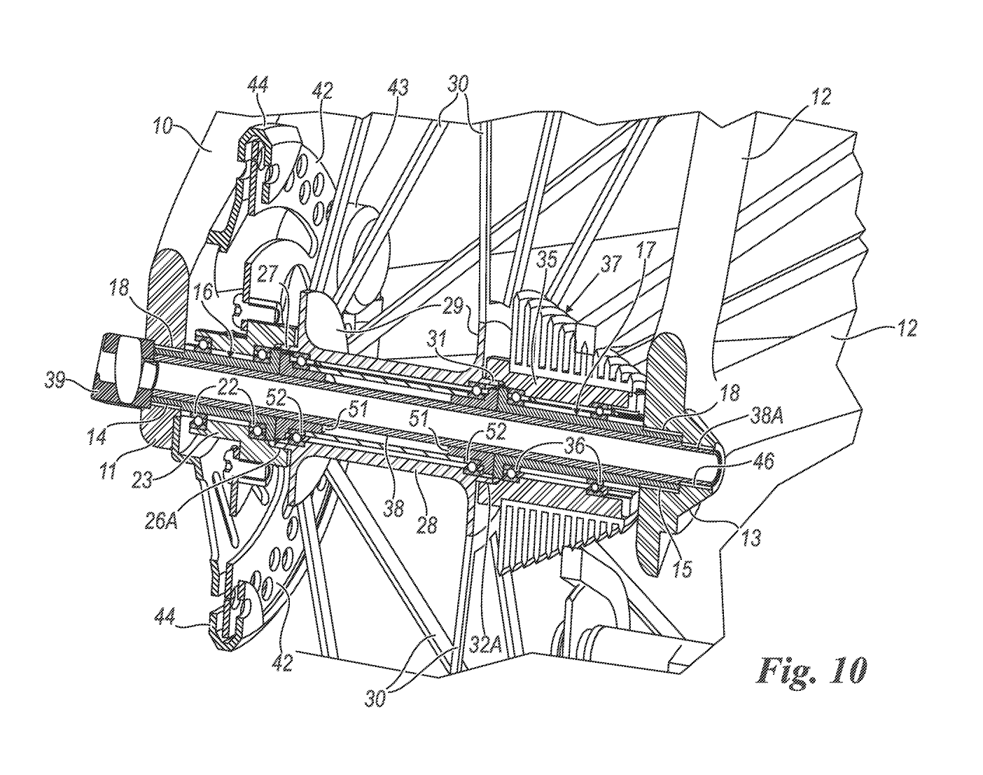

FIG. 10 is a cross-sectional perspective view of the portion shown in FIG. 7, obtained by cutting this portion along a vertical plane which passes through the axis of the rear wheel hub;

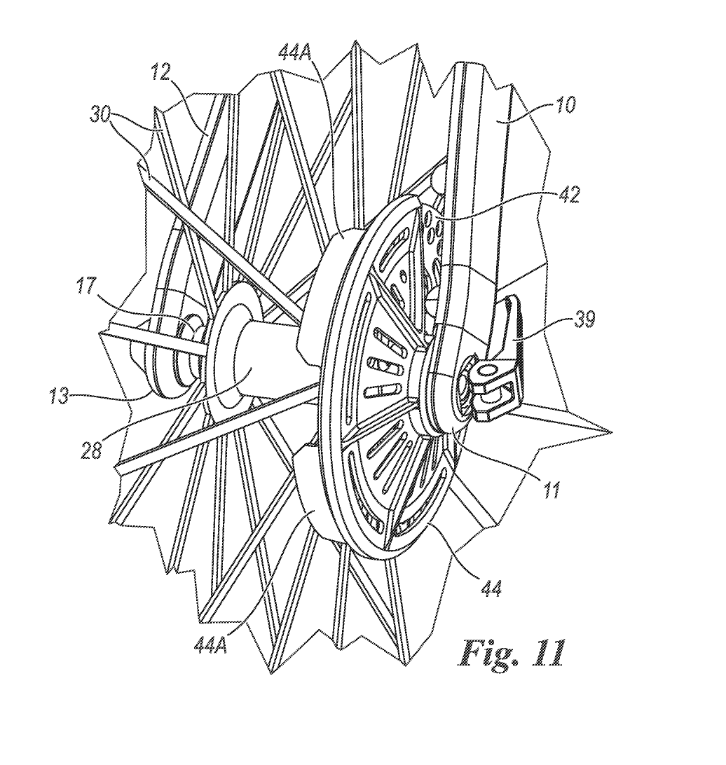

FIG. 11 is an enlarged perspective view, and from a different viewpoint, of a portion of the front part shown in FIG. 5;

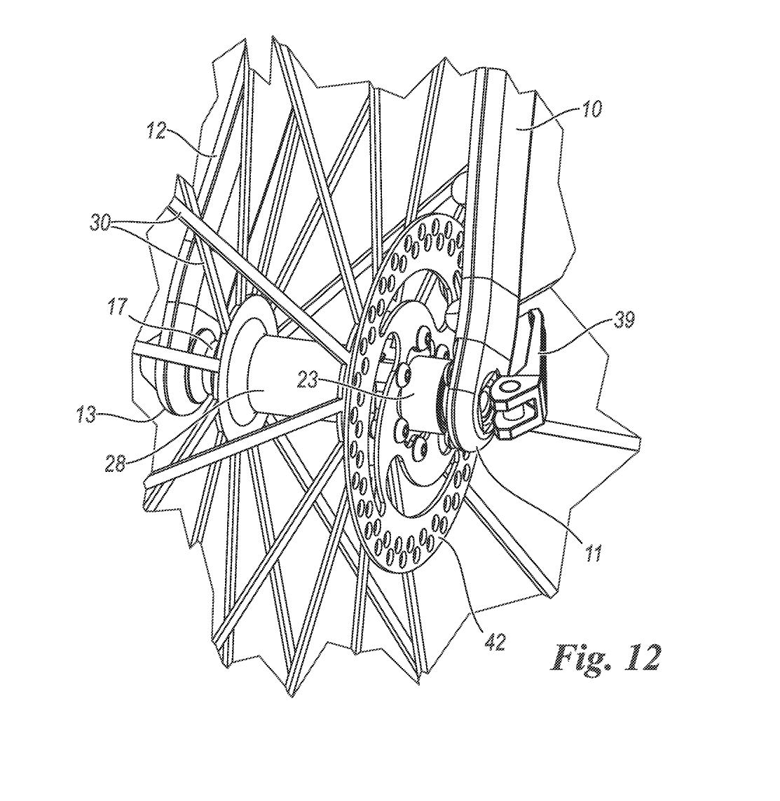

FIG. 12 is similar to FIG. 11, with the difference that the guard that protects the brake disc has been removed;

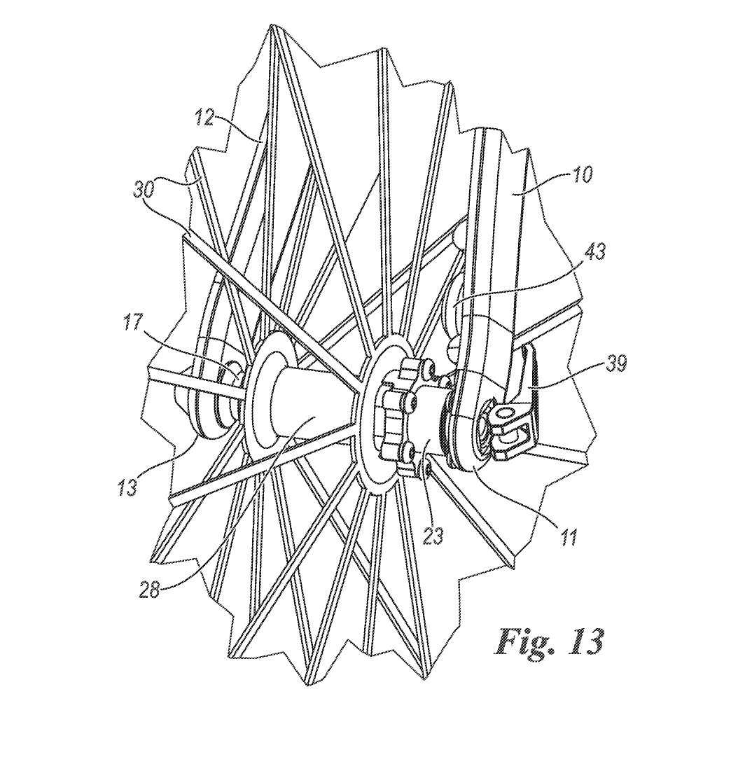

FIG. 13 is similar to FIG. 12, with the difference that the brake disc has also been removed;

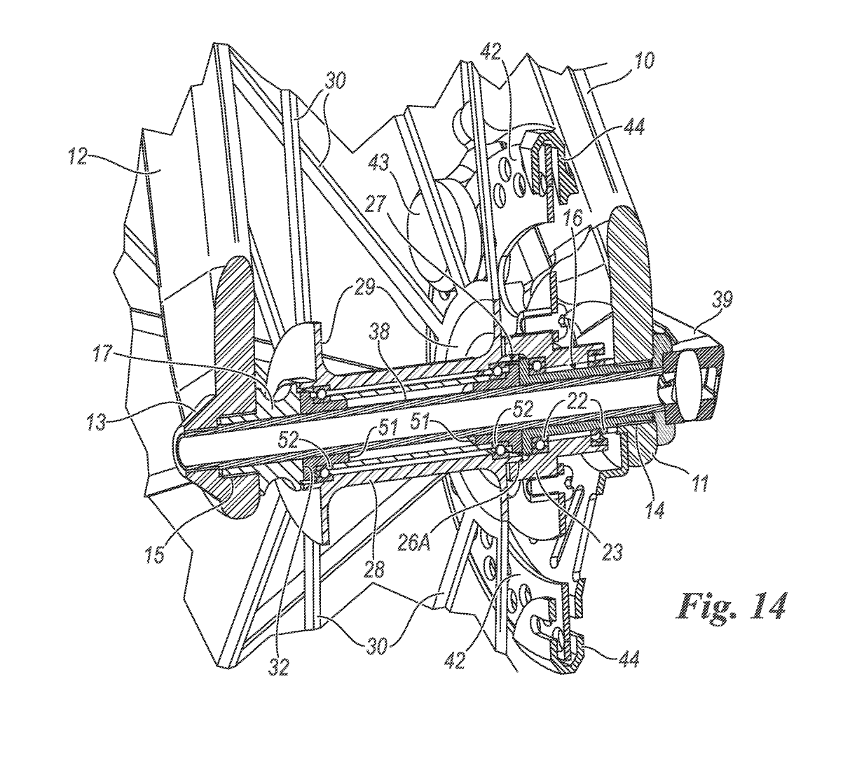

FIG. 14 is a cross-sectional perspective view of the portion shown in FIG. 11, obtained by cutting through this portion along a vertical plane that passes through the axis of the front wheel hub;

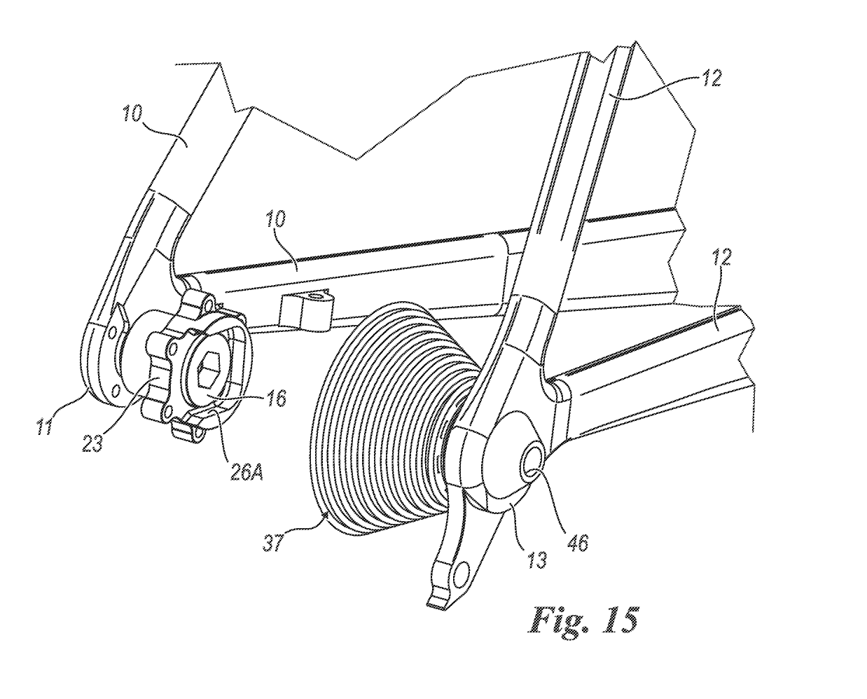

FIG. 15 is a perspective view that shows what remains connected to the rear fork of the second embodiment of the invention when the rear wheel, the guard, the disc and the transmission chain have been removed.

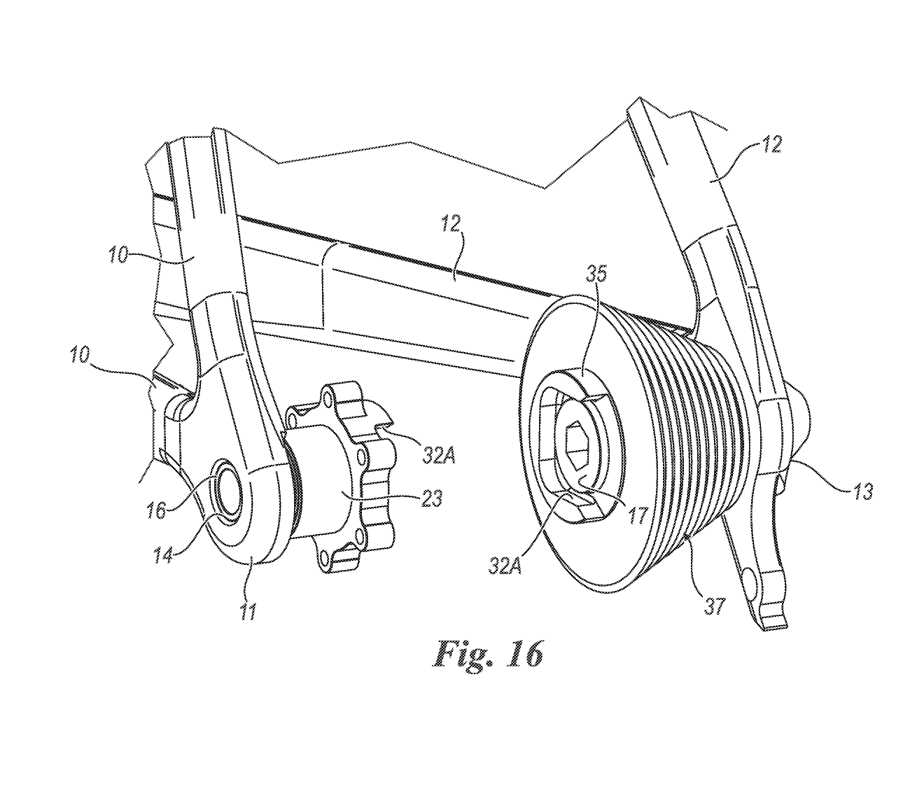

FIG. 16 shows that illustrated in FIG. 15, but from a different viewpoint;

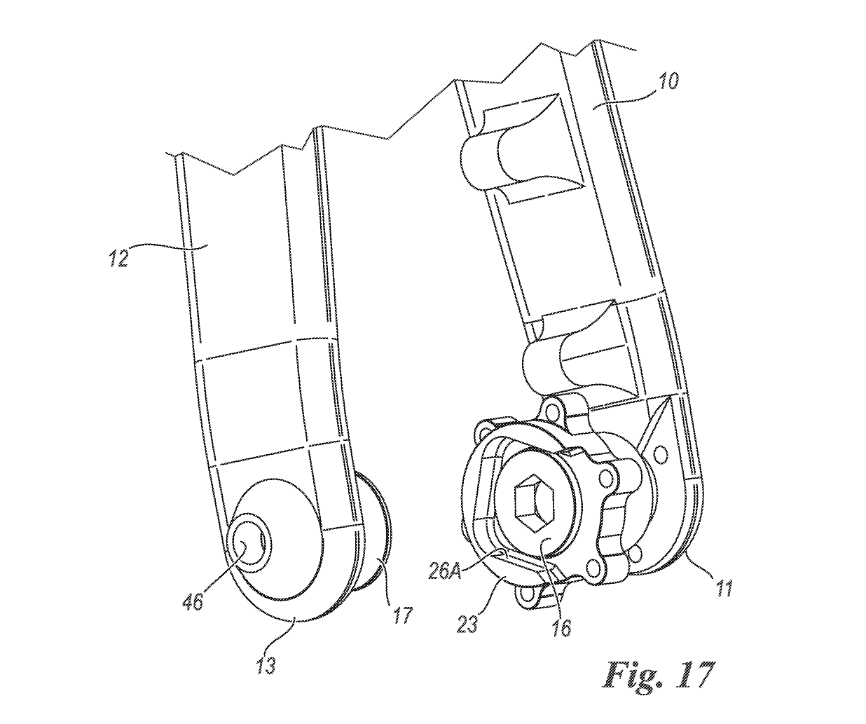

FIG. 17 is a perspective view that shows what remains connected to the front fork of the second embodiment of the invention when the front wheel, guard and disc have been removed;

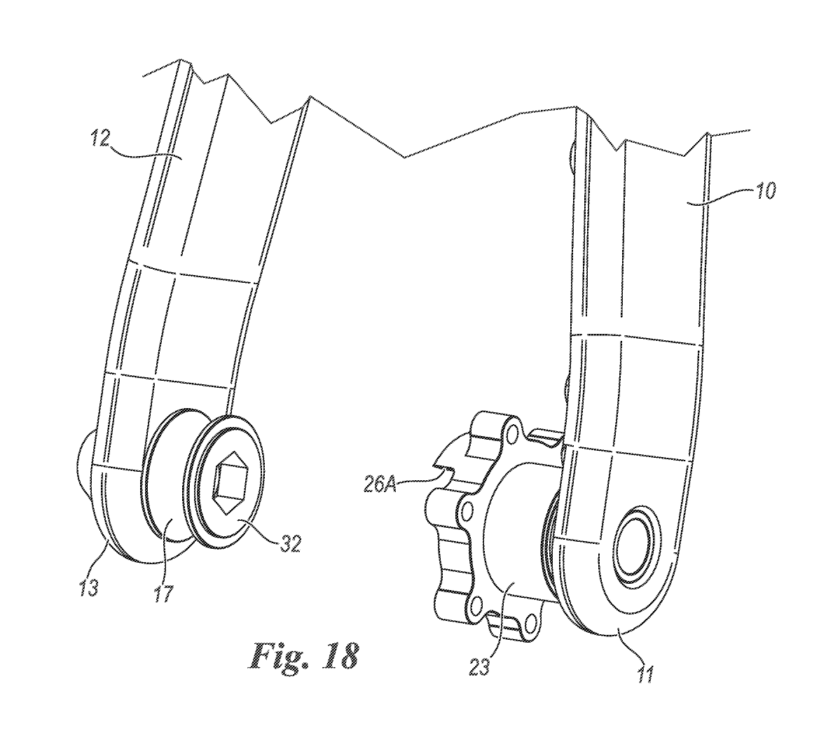

FIG. 18 shows that illustrated in FIG. 17, but from a different viewpoint;

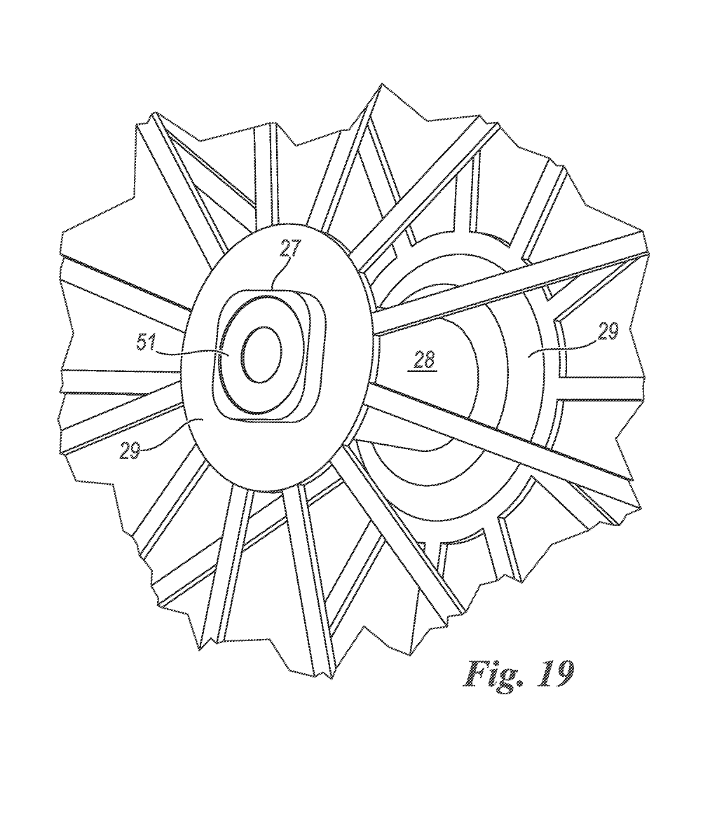

FIG. 19 is a perspective view of the hub of one of the two identical wheels of the above-mentioned second embodiment of the invention.

Before proceeding with the description of the Figures, we should point out that a situation similar to the one shown therein also concerns a bicycle with pedal assistance, in which a motor (in particular, an electric motor) assists or replaces the pedalling action of the cyclist.

FIGS. 1 and 2 show the bottom end of the two arms 10 and 12 of the rear fork of the frame of a bicycle according to the invention, the rear frame being designed to rotatably support the rear drive wheel (of which only the hub 28 and partially the spokes 30 are visible).

In the specific case illustrated, the arms 10 and 12 have one end part, 11 and 13 respectively, which is enlarged so as to be able to make therein a respective threaded cylindrical hole, indicated by 14 and 15, the two holes 14 and 15 being coaxial with each other and with the hub 28 of the relative wheel. Into each of the holes 14 and 15 is screwed the threaded end 18 of a relative coaxially hollow pin, indicated by 16 and 17 respectively (FIG. 2). In the specific case illustrated, the threaded end 18 is separated from the remaining part 20 of the pins 16 and 17 by a collar 21. When the threaded part 18 of the pins 16 and 17 is screwed fully home into the respective threaded hole 14 and 15, the collar 21 abuts directly or indirectly (as in the case illustrated) on the respective enlarged part 11 and 13 of the arms 10 and 12.

On the remaining part 20 of the pins 16 and 17 are mounted, spaced apart, two roller bearings, 22 and 36 respectively, which carry a bush, 23 and 35 respectively, which can however rotate freely and coaxially with the relative pin 16 and 17. In this specific case the bearings 22 and 36 (of which at least one per pair is of the thrust type) are kept apart by a ring spacer 25, interposed between them. At least part of the outer lateral surface of the bush 23, 35 is threaded so as to be able to screw onto it, until fully home, a cup element, 24 and 34 respectively, whose inner lateral surface is also threaded for this purpose.

The two cup elements 24 and 34 have externally, on their bottom wall facing the hub 28, a shaped profile and more precisely a coaxial recess (square-shaped in this specific case), indicated by 26 and 32 respectively, capable of connecting with a corresponding shaped profile, namely a protrusion which constitutes the relative end, 27 and 31 respectively, of the hub 28 of the bicycle's rear wheel, so as to achieve a positive-locking fit. More generally, we shall refer to the protrusions 27 and 31 as first shaped profiles and the recesses 26 and 32 as second shaped profiles. The recesses 26 and 32 may of course have a shape other than square, for example hexagonal or more generally polygonal, and even star-shaped, provided that it is capable of achieving the above-mentioned positive-locking fit with the respective protrusions 27 and 31 of the hub 28.

Advantageously, the recesses 26 and 32, as well as the relative protrusions 27 and 31 of the hub 28, have tapered lateral walls so as to allow the hub 28 to self-centre.

A variation may consist in providing the above-mentioned recesses on the hub and the corresponding protrusions on the bottom of the cup elements, thus achieving a positive-locking fit in this manner too.

Note that on each side of the hub 28 there is essentially an assembly, 53 and 54 respectively, comprising a part that is fixed in relation to the relative arm 10, 12 of the corresponding fork and formed by the pin 16 or 17, and by a rotating part, rotatably integral with the hub 28 after the coupling has been established, composed of the bush 23 or 35 and of the cup element 24 or 34, in which rotating part (in particular in the cup element) is provided the above-mentioned recess 26 or 32, each of the two assemblies 53 and 54 forming part of the means to rotatably support the hub 28.

The hub 28 is coaxially hollow and comprises two conventional collars 29 in order to secure the spokes 30 of the wheel.

Additionally, since the hub 28 is that of the rear wheel, on the bush 35 is coaxially mounted a conventional transmission element, indicated as a whole by 37, which forms part of the chain transmission device that allows the motion from the pedals to be transmitted to the rear wheel. The transmission element 37 may or may not comprise a conventional freewheel mechanism (not shown for simplicity), depending on requirements. In any case the rotation of the transmission element in one direction allows the bicycle's rear wheel to be driven forward.

Since the transmission element 37 is of a completely conventional type (in particular, by way of example, composed of a sprocket unit in the case of a chain transmission) and falling outside the scope of the present invention, it has merely been outlined in FIGS. 1 and 2 by dashed lines.

For the bicycle's rear wheel to be held in position, a tie-rod 38 is also provided, capable of being inserted into the hollow pins 16 and 17, and into the through-holes 46 made both in the enlarged free end 11 and 13 of the arms 10 and 12 of the bicycle's rear fork, and through the bottom wall (duly perforated) of the cup elements 24 and 34, as well as through the hollow hub 28. At one end of the tie-rod 38 is hinged a conventional lever with an eccentric element, indicated by 39, while at the other end of the tie-rod 38, an abuting element 40 can be removably fixed, which abuts against the arm 12 of the rear fork when the lever element 39 is forced into the position shown in FIG. 1, consequently placing the tie-rod 38 under tension.

The description relating to FIGS. 1 and 2 shows that, in order to remove the bicycle's rear wheel, the lever 39 must be moved to the position that allows the tie-rod 38 to be released and then the retaining element 40 (which, for example, is screwed onto the relative end of the tie-rod 38) to be removed from the tie-rod 38 so as to enable the tie-rod 38 to be withdrawn from the hub 28. The tie-rod 38, the lever 39 and the retaining element 40 essentially constitute the means that enable the above-mentioned positive-locking fit to be established between the two protrusions 27 and 31 of the hub 28 and the corresponding recesses 26 and 32 of the cup elements 24 and 34 when the tie-rod is under tension, and to nullify said positive-locking fit when the tie-rod 38 is released. The elasticity of the arms 10 and 12 of the rear fork (but also of the front fork) can form part of these means, elasticity that makes them, after releasing the tie-rod 38, individually slightly elastically flexible so as to make it possible, with minimum force, to move the two arms 10 and 12 slightly apart in order to remove the rear wheel from the bicycle frame once the tie-rod 38 has been withdrawn. Note that, once the wheel has been removed, the cup elements 24 and 34, the bushes 23 and 35 and the pins 16 and 17 remain connected to the respective arms 10 and 12 of the rear fork of the frame.

Note, however, that instead of relying on the elasticity of the arms 10 and 12, specific means can be provided. For example, a proper cylindrical hinge can be provided on one of the two arms 10 and 12, having its axis perpendicular to the tie-rod 38 (in FIG. 1 a cylindrical hinge 41 is provided on the arm 12). This hinge enables, by rotating the terminal part 13 of the arm 12 slightly outwards, the easy disengagement of the two ends 27 and 31 of the hub 28 from the relative recesses 26 and 32 of the cup elements 24 and 34 if the lever 39 is moved to its position of releasing the tie-rod 38, the abutting element 40 is removed from the end thereof and the tie-rod 38 is withdrawn.

Note that according to a variation of the embodiment relating to FIGS. 1 and 2, the rear wheel hub can be made so that its part opposite that closest to the transmission element 37 is of a traditional type, namely fitted with a roller bearing through which passes the tie-rod 38. In this case it is obvious that if both wheels of the bicycle are desired to be the same, the front wheel will also have its hub made in the same way, namely with one side of the hub different to the other.

Note also that the tie-rod 38 can be put under tension in other ways, instead of by means of the lever 39, for example by screwing a nut onto the corresponding threaded end of the tie-rod 38, which produces the same effect.

Returning to FIGS. 1 and 2, note that in the specific case illustrated, the disc 42 is in particular fixed coaxially (for example by screwing on directly or by means of screws) to the bush 23, whereas the calliper 43, which enables the pads to be pressed against the relative braking tracks of the disc 42, is fixed to the arm 10 of the rear fork. The disc 42 is therefore rendered independent of the rear wheel hub 28 and remains in position when the wheel is removed.

As a further variation, the calliper 43 can also be fixed directly to the pin 16 by means of a suitable support (not shown for simplicity). In this way, it is possible to use discs of the same thickness, but of different diameter, simply by changing the length of the support of the calliper 43, or by providing a support that allows the calliper to be fixed in different positions of the above-mentioned support, without the fork being directly involved.

Again, FIG. 1 shows that guards 44 and 45 (shown very schematically in the Figures) can be provided, carried, by means of the relative pin 16 and 17, by the corresponding arms 10 and 12 of the rear fork of the frame. These guards not only prevent the above-described drawbacks connected with overheating of the discs, but also prevent the front wheel of the bicycle of a racer who is behind from becoming wedged in the space between the disc and spokes of the rear wheel of the bicycle of the racer in front of him, or between this wheel and the sprocket unit.

As regards the bicycle's front wheel, since the above-mentioned transmission element (37) is not present, essentially the same situation as shown in FIGS. 1 and 2 exists, the sole difference being that there are no sprocket unit 37 and guard 45. In the case of the front wheel, if required, it is possible to arrange a second disc and a corresponding calliper also on the other side of the front wheel hub, like the disc 42 and the calliper 43 respectively, as shown in FIGS. 1 and 2 and also a relative guard like 44, thus obtaining for the disc brakes of the front wheel a perfectly symmetrical arrangement.

Before describing the second embodiment of the present invention, shown in FIGS. 3-19, note that, where possible, the same reference numerals will be used to indicate elements that are the same or similar to those of the embodiment shown in FIGS. 1 and 2.

FIGS. 3, 4, 7-10, 15 and 16 show that the arms 10 and 12 of the bicycle's rear fork carry the rear drive wheel 50, whose spokes 30 converge on the hub 28 which is rotatably supported by the above-mentioned fork. In the free end 11 and 13 of the arms 10 and 12, a respective threaded hole 14 and 15 is made (see FIG. 10), the two holes 14 and 15 being coaxial with each other and with the hub 28. Into each of the holes 14 and 15 is screwed a threaded end 18 of a relative hollow coaxial pin indicated by 16 and 17 respectively (see also FIGS. 15 and 16). On each of the pins 16 and 17 is mounted a pair of roller bearings, 22 and 36 respectively, which carry a bush, 23 and 35 respectively, which can however rotate freely and coaxially in relation to the relative pin 16 and 17. As shown, in this specific case, the two bushes 23 and 35 differ from each other but both have on their end facing the hub 28 a shaped profile, of the type that we have previously referred to as a second shaped profile, namely a coaxial recess, indicated by 26A and 32A respectively, which in this specific case is square with rounded edges, the two recesses 26A and 32A lacking, however, one lateral wall of the square, and therefore we will refer to them as C-shaped recesses. Each of these recesses is capable of connecting with a corresponding shaped profile, of the type which we have previously referred to as a first shaped profile, namely a square protrusion with rounded edges, which constitutes the relative end, 27 and 31 respectively (see also FIG. 19), of the hub 28, so as to achieve a positive-locking rotating fit between the bushes 23 and 35 and the hub 28. Note that the lack of a lateral wall of the two square recesses 26A and 32A enables an easy insertion of the square protrusions 27 and 31 of the hub 28 into the recesses 26A and 32A, as will be explained later.

The above-mentioned recesses may of course be other than square-shaped, they may for example be triangular or hexagonal, provided that the recess lacks a section of perimeter wall that allows the insertion in a direction perpendicular to the axis of the hub of corresponding protrusions of the hub, which must in any event rotatably connect with the respective recesses to ensure the rotatable coupling.

According to a variation, the above-mentioned section of lateral wall of the recesses, instead of lacking, may instead be removable.

Also as regards the above-mentioned second embodiment, it is clearly possible to envisage a variation according to which the above-mentioned C-shaped recesses are provided on the hub and the corresponding connecting protrusions on the relative bushes, thus achieving the desired positive-locking fit in this manner too.

Note that also for the second embodiment, on both sides of the hub 28 is an assembly comprising a part that is fixed in relation to the relative arm 10, 12 of the corresponding fork and composed of the pin 16 or 17 and relative ring nut 51, and a rotating part, rotatably integral with the hub 28 once the connection is established, composed of the bush 23 or 35, in whose rotating part (namely in the bush) is located the above-mentioned recess 26A or 32A, both of these two assemblies forming part of the means for rotatably supporting the hub 28.

Here too, the hub 28 is hollow (see FIG. 10) and comprises two conventional collars 29 for securing the spokes 30 (the collars and spokes being shown very schematically).

Note that the bush 23 differs from 35 in that to 23 is fixed the disc 42 of the braking system whereas 35 carries the sprocket unit 37.

In order to hold the wheel 50 in position, a tie-rod 38 is provided which in this specific case (FIG. 10) is hollow. The tie-rod 38, with the wheel 50 fitted, is inserted into the hollow pins 16 and 17 and passes lengthwise through the hub 28. One end 38A (the right end in FIG. 10) of the tie-rod 38 is threaded to enable it to be screwed into a corresponding threaded hole 46 made in the enlarged free end 13 of the arm 12 of the relative fork. At the other end of the tie-rod 38 here too a conventional lever element 39 is provided, with an eccentric element, which abuts against the arm 10 of the fork when the lever element 39 is forced into the position shown in the Figures, consequently placing the tie-rod 38 under tension.

Clearly, mechanisms other than the one just described can be used to place the tie-rod 38 under tension.

FIG. 10 also shows that inside the hollow hub 28, at both of its ends, two ring nuts 51 are provided through which the tie-rod 38 also passes. Each ring nut 51 is mounted on the hub 28 by means of a roller bearing 52. Once the wheel is fitted, on each ring nut 51 the relative pin 16 and 17 abuts, which means that the ring nuts 51 remain stationary when the wheel 50 turns.

At this point it should be clear that in order to remove the rear wheel 50 from the fork 10, 12, the lever 39 should merely be brought into the position that allows the tie-rod 38 to be released then rotate, by using the lever 39, the tie-rod about its axis so as to disengage its threaded end 38A from the threaded hole 46. Then the tie-rod 38 should merely be withdrawn to allow the wheel 50 to be released simply by pulling it in a direction perpendicular to the axis of the hub 28 so that the protrusions 27 and 31 of the hub come out of their respective recesses 26A and 32A through the open part of the C. It is easy to see that, in this second embodiment of the invention, the operation of replacing the wheel 50 is extremely simple.

In this case too (FIGS. 3, 4, 7 and 10) the disc 42 is protected by a guard 44 which, in addition to providing protection in the event of the disc 42 overheating when the wheel is in position, also prevents the front wheel of a bicycle from becoming wedged between the disc 42 and spokes 30, due to the fact that the guard 44 is fitted for this purpose with wings 44A (two of which can be seen in FIG. 7) protruding inwards and located in a position that prevents the creation of the above-mentioned “trap”.

There now follows a description of that shown in FIGS. 5, 6, 11-14, 17 and 18 that concern the front wheel of the same bicycle, using, as far as possible, the same reference numerals for the same or similar elements as those used for the rear wheel.

The above-mentioned Figures show that the front free wheel 60 is carried by the arms 10 and 12 of the front fork. In the free end 11 and 13 of the arms 10 and 12 a respective hole 14 and 15 is made (FIG. 14) coaxial with the hub 28. Into each of the holes 14 and 15 is screwed a hollow coaxial pin, 16 and 17 respectively (see also FIGS. 17 and 18), the two pins in this specific case differing somewhat from each other. While the pin 16 is like the similar pin, having the same reference numeral, relating to the rear wheel 50 and also serves to support rotatably, thanks to the roller bearings 22, a coaxial bush 23 having a C-shaped recess 26A, the pin 17, although having a threaded end screwed into the threaded hole 15 in the end 13 of the arm 12, is much simpler and has at its other end a substantially flat abutment face 32 whose function will be described later.

Here too, the C-shaped recess 26A is capable of coupling with a corresponding protrusion 27 (FIG. 19) of the hub 28 in order to achieve a rotating positive-locking fit between the bush 23 and the hub 28, while on the other side of the hub 28 the ring nut 51 inside the other square protrusion 27, with the wheel 60 fitted, simply abuts against the flat face 32 of the pin 17. Therefore, in the case of the front wheel 60, the rotating positive-locking fit with the hub 28 is achieved on one side of the hub only (between the recess 26A and the protrusion 27), on the other side the above-mentioned flat face 32, with the tie-rod 38 under tension, is simply required to press against the corresponding ring nut 51 mounted rotatably inside the relative end of the hub 28.

Clearly, therefore, the front wheel 60 too can be replaced just as quickly and simply as the rear wheel 50.

Note, however, that instead of the simplified connection that uses the pin 17, it is of course possible to use a connection of the type provided on the other side of the hub 28.

It is deemed unnecessary to add anything further regarding the front wheel, given that the elements shown in the relative Figures and not explicitly described are substantially identical to the corresponding elements relating to the rear wheel and have been indicated by the same reference numerals.

Note that in this case too, on both sides of the hub 28 is an assembly comprising a part that is fixed in relation to the relative arm 10, 12 of the corresponding fork and composed of the pin 16 or 17 and the relative ring nut 51, and a rotating part provided on one side only, which is rotatably integral with the hub 28 once the connection is established, composed of the bush 23, in whose rotating part (namely in the bush) is located the above-mentioned recess 26A, both of these two assemblies forming part of the means for rotatably supporting the hub 28.

Before concluding, it is important to emphasise the fact that the present invention enables bicycles to be produced, and in particular road competition bicycles, for which the danger of having to handle a wheel on which there are overheated and sharp discs no longer exists, given that the discs remain connected to the frame when the wheel is replaced. Furthermore, in the event of falls, particularly if in a group, thanks to the guards 44, there is no longer any danger that a cyclist can come into contact with the overheated and sharp discs of a bicycle.

Furthermore, the replacement of a wheel of a bicycle according to the invention, equipped with disc brakes, even in the case of a road competition bicycle, is decidedly quicker and simpler since it is no longer necessary to adjust the distance between the pads and the relative braking track of the disc (centring the disc), given that the discs are carried by the frame to which they remain attached during the replacement of the wheel. This also has the advantage that the disc brakes are not affected by the deformation of the relative wheel, thus avoiding interference between the pads and disc in the case of deformation of the wheel.

Moreover, if desired, thanks to the present invention, bicycles with disc brakes can be produced, and in particular road competition bicycles with disc brakes, in which the two wheels are perfectly identical, given that the above-mentioned transmission element is no longer fixed to the rear wheel hub, with all of the advantages that this brings if the wheels require replacement during a road competition, advantages that are certainly appreciated by the wheel-changing technicians, the team mechanics and the racers.

Note also that the presence of the appropriately shaped guards, in addition to preventing cuts and burns in the event of falls and during operations to replace the wheels of road competition bicycles, prevents falling into the previously mentioned “trap”.

Moreover, the present invention makes it possible, for any type of bicycle with disc brakes and a transmission device equipped with a transmission element rotatably integral with the drive wheel, to enclose in a special casing (not shown in the Figures for the sake of simplicity but whose configuration is obvious for an expert in the field) the entire device that transfers the motion to the drive wheel, the casing preventing the clothes or other objects worn by the user from coming into contact with the components of the transmission mechanism, thus preventing them from becoming caught up in it, with the risk of falls. A complete casing, which can even be sealed, also allows effective protection of the transmission device from dirt and dust and therefore also the lubrication of this device remains effective for longer.

Furthermore, thanks to the present invention, even non-specialists can easily, quickly and without danger manage to change, even on the spot, the wheels of a bicycle according to the invention.

It is in fact possible and easy for anyone to directly remove a damaged wheel on the spot, using simple small tools, obtain a new wheel and, still on the spot, replace it.

In view of the above, it is possible to conclude that the present invention constitutes a real revolution within the sector.

1. A bicycle with disc brakes, operated by a transmission device comprising a transmission element rotatably integral with the drive wheel and coaxial thereto, which comprises:
a frame equipped with a front and rear fork;
support means to rotatably, but removably, support at both ends the arms of each fork, the hub of a front free wheel and a rear drive wheel respectively, the support means comprising a tie-rod received in a coaxial through-hole provided in the hub as well as in relative holes provided at the free end of each arm of the relative fork, the tie-rod, when placed under tension by tensioning means, allowing the relative wheel to be held in position on the corresponding fork;
a brake with disc and calliper at least on one side of at least one wheel, the brake disc arranged coaxially to the relative wheel, the calliper with pads being fixed, directly or indirectly, to the corresponding arm of the fork;
wherein:
the discs are supported rotatably, directly or indirectly, by said arms to which is fixed the relative calliper;
a positive-locking fit allows the relative disc to be rotatably connected to the hub of the relative wheel;
means to establish the above-mentioned positive-locking fit when said tie-rod is under tension and to nullify said positive-locking fit when the tie-rod is released.

2. The bicycle according to claim 1, in which the transmission element comprises a freewheel mechanism.

3. The bicycle according to claim 1, in which:
the transmission element is supported rotatably by one of the arms of the rear fork of the frame;
a positive-locking fit allows the transmission element to be connected rotatably to the hub of the rear wheel, the positive-locking fit being established when said tie-rod is under tension and being nullified when the tie-rod is released.

4. The bicycle according to claim 3, in which, if the wheel is the rear one, meaning that the above-mentioned transmission element is present, the positive-locking fit is the same one that allows the corresponding disc to be rotatably connected to the hub of the rear wheel.

5. The bicycle according to claim 1, in which the support means to rotatably support the hub comprise a first shaped profile at at least one of the two ends of the hub, the first shaped profile for connecting, to establish said rotatably positive-locking fit, with a corresponding second connected shaped profile provided in an assembly also forming part of the support means for rotatably supporting the hub, said assembly comprising a part fixed in relation to the relative arm of the corresponding fork and a rotating part in which is provided the above-mentioned second shaped profile and rotatably integral with the hub when the connection is established, the disc being fixed to the above-mentioned rotating part.

6. The bicycle according to claim 5, in which the fixed part of the assembly comprises a pin coaxial with the hub when the wheel is fitted, one end of the pin being fixed to the relative arm of the corresponding fork, while the rotating part of the assembly comprises:
a bush mounted rotatably on the relative pin by means of roller bearings;
a cup element fixed coaxially to the bush and whose bottom, facing the relative end of the hub, has the above-mentioned second shaped profile;
the transmission element carried by the corresponding bush and/or by the corresponding cup element.

7. The bicycle according to claim 5, in which the fixed part of the assembly comprises a pin coaxial with the hub when the wheel is fitted, one end of the pin fixed to the relative arm of the corresponding fork, the other end of the pin abutting against a relative ring nut rotatably mounted in the hub and coaxial thereto, while the rotating part of the assembly comprises a bush rotatably mounted on the relative pin, the bush having the above-mentioned second shaped profile, the transmission element being carried by the corresponding bush.

8. The bicycle according to claim 6, in which the discs are fixed to the rotating part of the assembly.

9. The bicycle according to claim 7, in which the discs are fixed to the rotating part of the assembly.

10. The bicycle according to claim 1, in which the transmission device is of the chain type and the transmission element comprises at least one chain sprocket.

11. The bicycle according to claim 1, in which guards are provided for the discs, in the event that they overheat, the guards being carried directly or indirectly by the corresponding arm of the relative fork.

12. The bicycle according to claim 11, in which the guards for the discs are shaped to prevent the front wheel of another bicycle from becoming wedged in the space between the disc and spokes of the rear wheel.

13. The bicycle according to claim 1, in which a guard is provided shaped to prevent the front wheel of another bicycle from becoming wedged in the space between the spokes of the rear wheel and a transmission element, the guard being carried directly or indirectly by the corresponding arm of the relative fork.

14. The bicycle according to claim 1, in which the means to establish the above-mentioned positive-locking fit comprise:
a handle with an eccentric element hinged at one end of the tie-rod and abutting against the free end of one of the arms of the relative fork of the frame;
an abutting element to removably fix the other end of the tie-rod to the free end of the relative arm;
means that allow the wheel to be removed from the relative fork.

15. The bicycle according to claim 14, in which the means that allow the wheel to be removed comprise the elastic flexibility of the arms of the relative fork, which allows the free ends to be spread apart to such an extent as to allow the wheel to be taken out once the tie-rod has been removed.

16. The bicycle according to claim 14, in which the means that allow the wheel to be removed comprise a cylindrical hinge provided in one of the two arms, the hinge having its axis perpendicular to the tie-rod.

17. The bicycle according to claim 1, in which the means to establish the above-mentioned positive-locking fit comprise:
a handle with an eccentric element hinged at one end of the tie-rod and abutting against the free end of one of the arms of the relative fork of the frame;
an abutting element to removably fix the other end of the tie-rod to the free end of the relative arm;
means that allow the wheel to be removed from the relative fork;
wherein the means that allow the wheel to be removed comprises the rotatable positive-locking fit having a first shaped profile which connects with a second shaped profile which is a recess lacking lateral wall or having a removable section of lateral wall to enable the corresponding first shaped profile, in the form of a protrusion to be removed from said recess, by moving the wheel in a direction perpendicular to the axis of the hub.

18. The bicycle according to claim 1, in which a casing is provided for protecting the entire mechanism for the transmission of movement from the pedals to the rear wheel, including the transmission element.
